(19) United States
(12) Patent Application Publication
(10) Pub. No.: US 2012/0150856 A1
(43) Pub. Date: Jun. 14, 2012

(54) System and method of ranking web sites or web pages or documents based on search words position coordinates

(76) Inventor: Pratik Singh, (US)

(21) Appl. No.: 12/965,872

(22) Filed: Dec. 11, 2010

(51) Int. Cl. G06F 17/30

(52) U.S. Cl. 707/729; 707/723; 707/E17.014

(57) ABSTRACT

The described systems and methods are directed to ranking web sites or web pages or documents, on internet or intranet, when two or more search words are used to search for web sites or web pages or documents on internet or intranet. Rank of web sites or web pages or documents will be based on the positional correlation matrix created using paired positional correlation of the search words. In order to calculate paired positional correlation; search words will be indexed within a web site or web page or document based on the position of the sentences, in which they occur, and their position within the sentences. It is possible that contents of web sites or web pages or documents are in tabular form instead of textual/descriptive form, in that case, either columns or rows or any other order of table cells can be considered as equivalent to a sentence and can be used to index the search words. Positional correlation matrix can be a, but not limited to, two dimensional representation of the paired positional correlation of the search words. Rank of the web site or web page or document will be based on relevance score, which will, at least in part, be based on search words cumulative paired positional correlation taken from positional correlation matrix. Performance of the system can be improved by calculating positional correlation matrix for web sites or web pages or documents, in advance, based on the key words. Key words can be referred to as the words that web site or web page or document claims to be the best source of information. Relevance score, of the web site or web page or document, can then be readily calculated by picking the paired positional correlation of the search words from the positional correlation matrix of key words, calculated earlier.

### BACKGROUND

1. Field of the Invention

The present invention generally relates to content analysis of web sites or web pages or documents, and more particularly, to a system and method of ranking of the web sites or web pages or documents, existing on intranet or internet, for the search query submitted by the user.

2. Description of the Related Art

As more and more information is digitized and stored in electronic format; it's becoming more and more difficult for the users to have direct access to the information they are looking for. This is true both for the users of internet and intranet. Search engines are playing a very important role in pointing users to the information that they are looking for.

Search engines rank the web sites/web pages/documents and display the list in the order, based on the relevance score, calculated for the web sites/web pages/documents for the search query submitted by the users. Page ranking, vector-space and probabilistic model are some of the known models that can be used for ranking web sites/web pages/documents. Many of the current search engines use one or more combinations of one or more derivations of page ranking or vector-space or probabilistic models along with proprietary models developed by the search engine developers. All of these common models suffer from known major drawbacks, like page ranking model and its derivatives suffer from typical chicken and egg problem. A new page containing the most relevant information may get ignored just because the page is new and there are no links pointing to it, since this page is new and doesn't show up high in the list, there are fair chances that this page will continue to be ranked lower. Other models are either too simplistic to order relevant web sites/web pages/documents or too complex to implement. Other major problem is the lack of transparency. There is no way to challenge the rank of web sites/web pages/documents, shown to the users, and it's possible that results are biased either intentionally or un-intentionally.

Thus, there is a need in the art for improved relevance score calculations for the ranking of web sites/web pages/documents.

### BRIEF DESCRIPTION OF THE DRAWINGS

FIG. 1: Provides a simplified view of an embodiment of ranking system

FIG. 2: Provides a simplified view of an embodiment of enhanced ranking system

FIG. 3: Provides a detailed view of the ranking system shown in FIG. 1

FIG. 4: Provides a detailed view of the enhanced ranking system shown in FIG. 2

FIG. 5-a: Displays sample input screen user can use to challenge the ranking

FIG. 5-b: Displays sample output of the challenge

FIG. 6: Displays feature of showing positional correlation matrix of the web sites/web pages/documents in the list

### DETAILED DESCRIPTION

In accordance with this invention: following are the definition of the terms used to describe the invention:

word(s,p): Referred to as “positional coordinates” of the word in any web site/web page/document. ‘s’ is the index of the sentence in which ‘word’ appears in the web site/web page/document, ‘p’ is the index of the ‘word’ within the sentence. For example, Ford(2,3) would mean that the word ‘Ford’ appears in the 2nd sentence and is the 3rd word within the sentence. Index can either start from ‘0’ or ‘1’. Embodiments described here use index starting from 1.

LOC(s,p): Generic representation of ‘word(s,p)’ referring to the concept of positional coordinates.

PCRR(word1,word2): Referred to as “Paired Positional Correlation of word1 and word2” in any web site/web page/document. PCRR(word1,word2) is a function of word1(s,p) and word2(s,p) and can be represented as PCRR(word1,word2)=f(word1(s,p),word2(s,p)).

The present invention will now be described more fully hereinafter with reference to the accompanying drawings, which form a part hereof, and which show, by way of illustration, specific exemplary embodiments for practicing the invention. In the interest of clarity, not all of the routine features of the implementations described herein are shown and described. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense. Use of the concept of word(s,p) and/or PCRR(word1,word2) in tandem with or without any existing/new/proprietary statistical and/or non-statistical method, still falls in the scope of this claim.

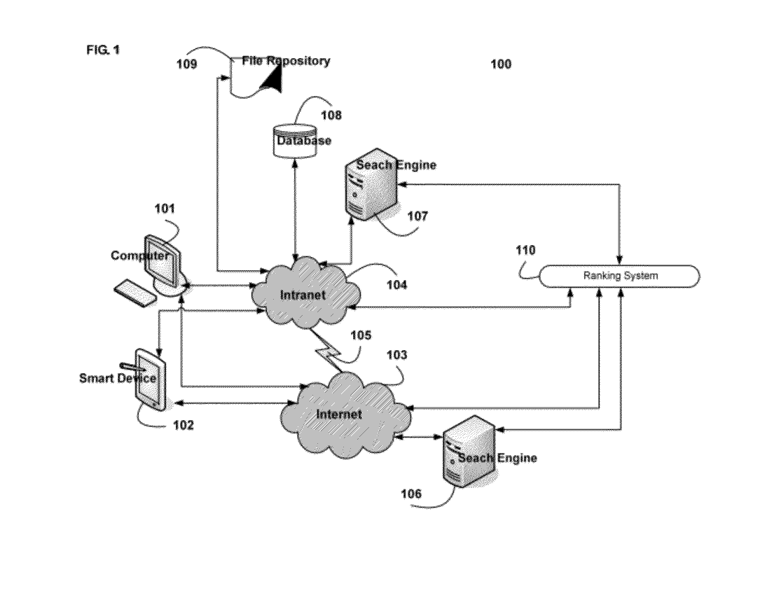

FIG. 1 shows a block diagram depicting a typical network system 100 for conducting searches for web sites or web pages or documents on intranet or internet. The network system 100 is only one example of a suitable computing environment and is not intended to suggest any limitations as to the scope of use or functionality of the invention. Neither should the network system 100 be interpreted as having any dependency or requirement relating to any one or more combinations of components illustrated in the exemplary network system 100.

Aspects of the invention may be described in the general context of computer-executable instructions, such as program modules, being executed by a computer or server. Generally, program modules include routines, programs, objects, components, data structures, and the like that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices. As stated earlier, computer-executable instructions can either be embodied as software or hardware or a combination of both hardware and software.

As is shown, the network system 100 includes:

101. Computer

102. Smart Device

103. Internet network

104. Intranet network

105. Communication link between Intranet and Internet

106. Search Engine, processing search requests targeted for internet

107. Search Engine, processing search requests targeted for intranet

108. Database based repository, for storing website content or documents for intranet

109. File based repository, for storing website content or documents for intranet

110. Ranking System, containing one or more embodiments of current invention

Network components, listed above, may communicate with each other via any number of methods known in the art, including wired and wireless communication. In the interest of clarity, not all of the features, including but not limited to public-switched telephone network, gateways or other server devices, and other network infrastructure provided by Internet service providers, of the implementations described herein are shown and described.

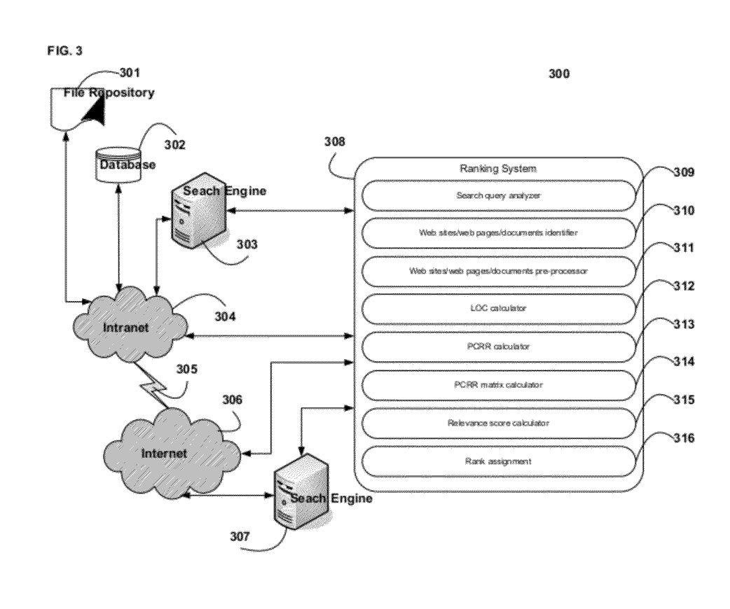

As shown in FIG. 1, user can use either computer or smart device, henceforth referred to as user devices, capable of connecting to either internet or intranet, to conduct the search for web sites or web pages or documents. User devices can either be connected to internet network 103 directly or through intranet network 104, connected to internet network 103 using communication link 105. Search engine can be part of either intranet network or intranet network. Search engine 106 is connected to internet network and can be accessed by the user to conduct search on internet. Search engine 107 is connected to intranet network and can be accessed, by the user, to conduct search on intranet. Search engines 106; 107 will receive query from the user and use ranking system 110 to fetch list of web sites/web pages/documents ordered on the basis of relevance score and send the list, containing web sites or web pages or documents, back to the user. Ranking system 110, one of the embodiments of the current invention, will access the web sites or web pages or documents, in the realm, either on internet or intranet, and calculate positional correlation matrix for the search words contained in the query, submitted by the user. Ranking system 110 will then create the list of web sites/web pages/documents ordered on the bases on the relevance score, calculated from search words positional correlation matrix of the corresponding web sites/web pages/documents. Realm can be described as the scope within which web sites or web pages or documents are to be considered. Ranking system 110 has been described in more details in FIG. 3.

FIG. 3 illustrates ranking system, shown in FIG. 1, in more details. As is shown, FIG. 3 includes:

301. File based repository, for storing website content or documents on intranet

302. Database based repository, for storing website content or documents on intranet

303. Search Engine, processing search requests targeted for intranet

304. Intranet network

305. Communication link between Intranet and Internet

306. Internet network

307. Search Engine, processing search requests targeted for internet

308. Ranking system

309. Search query analyzer: sub-module to fetch search words from the search query submitted by the user

310. Web sites/web pages/documents identifier: sub-module to identify web sites/web pages/documents in the search realm

311. Web sites/web pages/documents pre-processor: sub-module to process the web sites/web pages/documents, identified by 310, and create corresponding text equivalent if required

312. LOC calculator: sub-module to parse web sites/web pages/documents or their text equivalent, created by sub-module 311, and calculates positional coordinates, for each of the search words, created by sub-module 309

313. PCRR calculator: sub-module to create paired positional correlation based on the positional coordinates calculated by sub-module 312

314. PCRR matrix calculator: sub-module to create positional correlation matrix based on the paired positional correlation calculated by sub-module 313

315. Relevance score calculator: sub-module to calculate relevance score based on the positional correlation matrix created by sub-module 314

316. Rank assignment: sub-module to create the list of web sites/web pages/documents ordered by the relevance score, calculated by sub-module 315, for each of the web sites/web pages/documents

FIG. 3 focuses on the major components of the Ranking system shown in FIG. 1. Sub-modules described in FIG. 3 are for illustration of the invention and are not intended to be in any way limiting; as those of ordinary skill in the art will realize that the sub-modules described in FIG. 3 can either be further re-factored into sub-modules or combined to create a new sub-module.

Following is a more descriptive explanation of the sub-modules of the Ranking system shown in FIG. 3.

Search engine, either 303 or 307, pass search query, submitted by the user, to Ranking system 308. Ranking system 308 comprises of the sub-modules which do the actual work. Sub-module 309 parses the search query, submitted by the user, and identifies the search words. Sub-module 309 can choose from numerous ways to parse search query and store the search words. For example, if user submits “ford car” as search query, then sub-module 309 can either create simple string array object {“ford”,“car”} or create complex array of objects like {{“ford”,“1”},{“car”,“2”}}. Main module 308 then passes search words to sub-module 310. Sub-module 310 identifies web sites/web pages/documents in the realm. Method of identifying web sites/web pages/documents in realm may include, but not limited to, static or dynamic or combination of static and dynamic segregation of web sites/web pages/documents. Static segregation, for example, can be based on search engine. So if search query is send by blogs specific search engine, than web sites/web pages/documents in the realm will only be the web sites/web pages/documents related to blogs. Dynamic segregation can be based on search words. So for example, if search words contain term “automobile” then web sites/web pages/documents realm could be the pre indexed automobile related web sites/web pages/documents. Control is now passed on to sub-module 311, which takes, as input, the list of web sites/web pages/documents identified by sub-module 310, and creates text equivalent of the web sites/web pages/documents if necessary. If web sites/web pages/documents contain information in tabular format then the tabular data will be transformed into paragraphed/textual format. For example, if web site/web page/document contains data as shown below:

| Car | model | Year |
|---|---|---|
| Ford | F150 | 2006 |
| Ford | F350 | 2010 |
| Toyota | Avalon | 2010 |

Then sub-module 311 may transform the tabular format data, shown above, into the following:

“Car model year. Ford F150 2006. Ford F350 2010. Toyota Avalon 2010.”

Control is now passed to sub-module 312 which calculates positional coordinates, represented by LOC(s,p), of the search words. Sub-module 312 can either refer to the web sites/web pages/documents, identified by sub-module 310, directly and/or may refer to their text equivalent, if there exists one, created by sub-module 311. If sub-module 309 created search word array like {“Ford”,“F150”,“2010”}; then, sub-module 312 will calculate location coordinates for each of the search words: ‘Ford’,‘F150’,‘2010’. For simplicity let's assume that the realm of web sites/web pages/documents for this particular search contains 2 documents: Doc1 and Doc2.

Let's say Doc1 contains following text:

“Ford F150 model 2010 available for sale. Ford F350 model 2010 available for rental. Ford F150 refurbished model 2010 available for lease. Ford F350 model 2008 available for trade-in. Ford F150 model 2005 with 200,000 miles on it available for sale really cheap. Ford F350 model 2002 available for trade-in. Toyota Avalon 2010 available for sale”

Doc2 contains following text:

“Ford F150 is a very good truck, I am very much satisfied with it. Ford F150 has received very good consumer reviews and that's the reason I brought this truck. Only problem is lack of power, I wish I had purchased Ford F350. Ford F150 may be under powered, but fuel economy is superb. Ford F150 has been placed at top 5 most fuel efficient trucks. Other advantage of Ford F150 is that my wife can also drive it very easily. Ford dealer is located close to our house and it's easy for me to go get my F150 serviced in no time whenever it's needed. Since I brought my Ford F150 in January 2010, I have had no problems. It's been good 2010 so far. Some Ford F150 models seem to develop cracked paint, but luckily I am fine”.

Based on the content of Doc1 and Doc2, sub-module 312 will generate location coordinates of the search words as shown below:

Doc1:

Ford: (1,1),(2,1),(3,1),(4,1),(5,1),(6,1)

F150: (1,2),(3,2),(4,2)

2010: (1,4),(2,4),(3,5),(7,3)

Doc2:

Ford: (1,1),(2,1),(3,12),(4,1),(5,1),(6,4),(7,1),(8,5),(10,2)

F150: (1,2),(2,2),(4,2),(5,2),(6,5),(7,18),(8,6),(10,3)

2010: (8,9),(9,4)

(Table 2)

Sub-module 313 will take the location coordinates of search words, calculated by sub-module 312, and calculate paired positional correlation, represented by PCRR(a,b), for all possible search word pairs. So PCRR(Ford,F150) would mean paired positional correlation of search words ‘Ford’ and ‘F150’.

For the sake of simplicity and clarity, calculations shown below are based on assumption that sub-module 313 uses following formula to arrive at PCRR(searchword-x, searchword-y)

PCRR(searchword-x, searchword-y)=(n**2)*Σ1/(abs(x−y))

Where

n=number of sentences in with both search words (searchword-x and searchword-y) occurs together. So for Doc2 LOC(Ford): (3,12) will be ignore as “F150” doesn't occur in 3^{rd} sentence and will not be used for calculating PCRR(Ford,F150)

x=position of searchword-x in the sentence

y=position of searchword-y in the sentence

abs(x−y)=absolute value of the difference between numbers x and y. So value of abs(3−4) will be 1 and value of abs(4−3) will also be 1

Σ=summation of the series. For e.g., if x is a series: [symbol] , then Σ1/x=(1/1+1/3+1/4)

*=multiplication, so 2*4=8

**=square, so 3**2=3*3=9

Taking the sample output for search word location coordinates for Doc1 and Doc2, shown in Table 2, following are the calculations for creating paired positional correlations:

Doc1:

| | | | | | PCRR(Ford, F150) |
|---|---|---|---|---|---|
| Ford | F150 | | 1/ | Σ1/ | (n**2) * Σ1/ |
| x | y | abs(x − y) | abs(x − y) | (abs(x − y)) | (abs(x − y)) |
| 1 | 2 | 1 | 1 | 3 | 27 |
| 1 | 2 | 1 | 1 | | |
| 1 | 2 | 1 | 1 | | |

n = 3
n**2 = 9

| | | | | | PCRR(Ford, 2010) |
|---|---|---|---|---|---|
| Ford | 2010 | | 1/ | Σ1/ | (n**2) * Σ1/ |
| x | y | abs(x − y) | abs(x − y) | (abs(x − y)) | (abs(x − y)) |
| 1 | 4 | 3 | 0.333333 | 0.916667 | 8.25 |
| 1 | 4 | 3 | 0.333333 | | |
| 1 | 5 | 4 | 0.25 | | |

n = 3
n**2 = 9

| | | | | | PCRR(F150, 2010) |
|---|---|---|---|---|---|
| F150 | 2010 | | 1/ | Σ1/ | (n**2) * Σ1/ |
| x | y | abs(x − y) | abs(x − y) | (abs(x − y)) | (abs(x − y)) |
| 2 | 4 | 2 | 0.5 | 0.833333 | 3.333332 |
| 2 | 5 | 3 | 0.333333 | | |

n = 2
n**2 = 4

Doc2:

| | | | | | PCRR(Ford, |
|---|---|---|---|---|---|
| | | | | | F150) |
| Ford | F150 | | | Σ1/ | (n**2) * Σ1/ |
| x | y | abs(x − y) | 1/abs(x − y) | (abs(x − y)) | (abs(x − y)) |
| 1 | 2 | 1 | 1 | 7.058823529 | 451.76471 |
| 1 | 2 | 1 | 1 | | |
| 1 | 2 | 1 | 1 | | |
| 1 | 2 | 1 | 1 | | |
| 4 | 5 | 1 | 1 | | |
| 1 | 18 | 17 | 0.05882353 | | |
| 5 | 6 | 1 | 1 | | |
| 2 | 3 | 1 | 1 | | |

n 8
n**2 64

| | | | | | PCRR(Ford, |
|---|---|---|---|---|---|
| | | | | | 2010) |
| Ford | 2010 | | | Σ1/ | (n**2) * Σ1/ |
| x | y | abs(x − y) | 1/abs(x − y) | (abs(x − y)) | (abs(x − y)) |
| 5 | 9 | 4 | 0.25 | 0.25 | 0.25 |

n 1
n**2 1

| | | | | | PCRR(F150, |
|---|---|---|---|---|---|
| | | | | | 2010) |
| F150 | 2010 | | | Σ1/ | (n**2) * Σ1/ |
| x | y | abs(x − y) | 1/abs(x − y) | (abs(x − y)) | (abs(x − y)) |
| 6 | 9 | 3 | 0.33333333 | 0.333333333 | 0.3333333 |
| n 1 | | | | | |
| n**2 1 | | | | | |

So for Doc1 PCRR scores (approximated to 2 decimal points) are as follows:
PCRR(Ford,F150)=27
PCRR(Ford,2010)=8.25
PCRR(F150,2010)=3.33

For Doc2 PCRR scores (approximated to 2 decimal points) are as follows:
PCRR(Ford,F150)=451.76
PCRR(Ford,2010)=0.25
PCRR(F150,2010)=0.33

Control is now passed to sub-module 314, which calculates PCRR Matrix from PCRRs calculated by sub-module 313. Referring to the PCRR outputs of sample calculations shown for sub-module 313 previously; following is one of the ways in which sub-module 314 can create PCRR matrix:

TABLE 3

| | | |
|---|---|---|
| Ford | F150 | 2010 |

PCRR-Doc1

| | | | |
|---|---|---|---|
| Ford | — | 27 | 8.25 |
| F150 | 27 | — | 3.33 |
| 2010 | 8.25 | 3.33 | — |

PCRR-Doc2

| | | | |
|---|---|---|---|
| Ford | — | 451.76 | 0.25 |
| F150 | 451.76 | — | 0.33 |
| 2010 | 0.25 | 0.33 | — |

Sub-module 315 will calculate relevance score of each of the web sites/web pages/documents based on the PCRR matrix created by sub-module 314. There are numerous ways in which sub-module 315 can calculate relevance score. Following description shows the use of simple relevance score calculation method based on direct comparison of search words PCRR values. Referring to the PCRR matrix created by sub-module 314 (shown in Table 3), relevance score will be as follows:

TABLE 4

| | (Ford, F150) | (Ford, 2010) | (F150, 2010) |
|---|---|---|---|
| Doc1 | 2 | 1 | 1 |
| Doc2 | 1 | 2 | 2 |

As shown in the table above; Doc1 has been assigned score of 2 for (Ford, F150) because its rank out of 2 documents for PCRR(Ford, F150) is 2^{nd} [PCRR(Ford, F150)−Doc1=27 and PCRR(Ford, F150)−Doc2=451.76]. Similarly Doc1 has been assigned score of 1 for (Ford,2010) as its rank out of 2 documents for PCRR(Ford,2010) is 1^{st}. Doc1 has been assigned score of 1 for (F150, 2010) as its rank out of 2 documents for PCRR(F150,2010) is 1^{st}. Similarly ranks are calculated for Doc2.

There are numerous ways to calculate final score. For the sake of simplicity, let's assume that Sub-module 315 assigns equal weightage to all the pairs, and calculates final score based on sum of all the scores of the search word pairs. So final score calculated by sub-module 315 will be as follows:

Doc1: 4 (2+1+1)

Doc2: 5 (1+2+2)

(Table 5)

There is a possibility of a tie in which 2 or more web sites/web pages/documents have the same score. In that case additional criteria can be used to rank web sites/web pages/documents. For example, if 2 documents have same score, then rule can be set that whichever web site/web page/document has higher ranking for the first pair of search words will be ranked higher.

Sub-module 316 takes output of sub-module 315 and prepares the list of web sites/web pages/documents in order of the relevance score. So referring to the output of sub-module 315, shown in table 5, sub-module 316 will prepare the list as:

Doc1

Doc2

indicating that Doc1 has relatively more relevant information then Doc2. List of web sites/web pages/documents will be returned to the search engine, 303 or 307.

Search engine 303 or 307 will subsequently return the list of web sites/web pages/documents to the user.

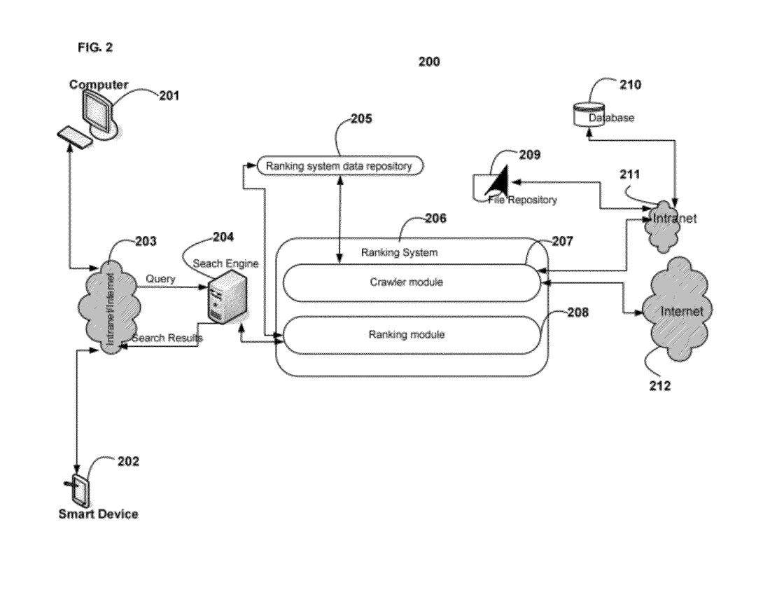

FIG. 2 shows a block diagram of ranking system similar, but improved, to the one shown in FIG. 1. The network system 200 is only one example of a suitable computing environment and is not intended to suggest any limitation as to the scope of use or functionality of the invention. Neither should the network system 200 be interpreted as having any dependency or requirement relating to any one or more combinations of components, illustrated in the exemplary network system 200.

As is shown, the network system 200 includes:

201. Computer

202. Smart Device

203. Network, this can be either internet network or intranet network

204. Search Engine

205. Ranking system data repository

206. Ranking system

207. Ranking system: ‘Crawler’ module

208. Ranking system: ‘Ranking’ module

209. File based repository, for storing website content or documents on intranet

210. Database based repository, for storing web site content or documents on intranet

211. Intranet network

212. Internet network

Network components, listed above, may communicate with each other via any number of methods known in the art, including wired and wireless communication.

In the interest of clarity, not all of the features, including but not limited to public-switched telephone network, gateways or other server devices, and other network infrastructure provided by Internet service providers, of the implementations described herein are shown and described.

As shown in FIG. 2, ranking system in this embodiment runs parallel in two modes. In 1^{st} mode Ranking System: Crawler module 207 runs while in the 2^{nd} mode Ranking System: Ranking module 208 runs.

Following is the description of the working of Ranking System: Crawler module 207. Ranking system crawler module 207 constantly looks for web sites/web pages/documents on internet and/or intranet and creates PCRR matrix for all the web sites/web pages/documents based on their respective key words. Web sites/web pages/documents key words can be referred to as the set of words for which web sites/web pages/documents claim to be the best source of information. Crawler module 207 subsequently calls Ranking system data repository 205 to store PCRR matrix and corresponding web sites/web pages/documents details. Through intranet, Crawler module 207 can access web sites/web pages/documents, on intranet, in file repository 209 and in database 210. File repository 209 do not refer to just one repository, there can be multiple file repositories, similarly database 210 do not refer to just one instance of database but could be multiple instances.

Following is the description of the working of Ranking System: Ranking module 208. User uses computer 201 or smart device 202, henceforth referred to as user devices, to conduct the search for web sites or web pages or documents. User accesses search engine 204 and submits search query. Search engine 204 forwards the request to ranking module 208. Ranking module 208 uses ranking system data repository 205, by forwarding search query to ranking system data repository 205 and get back PCRR matrix and details of the relevant web sites/web pages/documents. Ranking system data repository 205 identifies relevant web sites/web pages/documents based on the search query forwarded by ranking module 208. For example, if search query consist of search words: “Ford,F150,2010” then ranking system data repository 205 will only send PCRR matrix for the web sites/web pages/documents containing all 3 search words: “Ford”, “F150” “2010” as key words, in the PCRR matrix. It is also possible that ranking system data repository 205 includes web sites/web pages/documents, containing fewer search words in the PCRR matrix, this may be because there are not many web sites/web pages/documents containing all the search words. Ranking system ranking module 208 then uses PCRR matrix of all the web sites/web pages/documents, sent by ranking system data repository 205, to calculate the relevance score for each of the web sites/web pages/documents and rank them on the basis of relevance score. Ranking system ranking module 208 then sends back the list of web sites/web pages/documents back to the Search Engine 204. Search engine 204 then respond back, to the user, with the list of web sites/web pages/documents list, returned to it by ranking system ranking module 208.

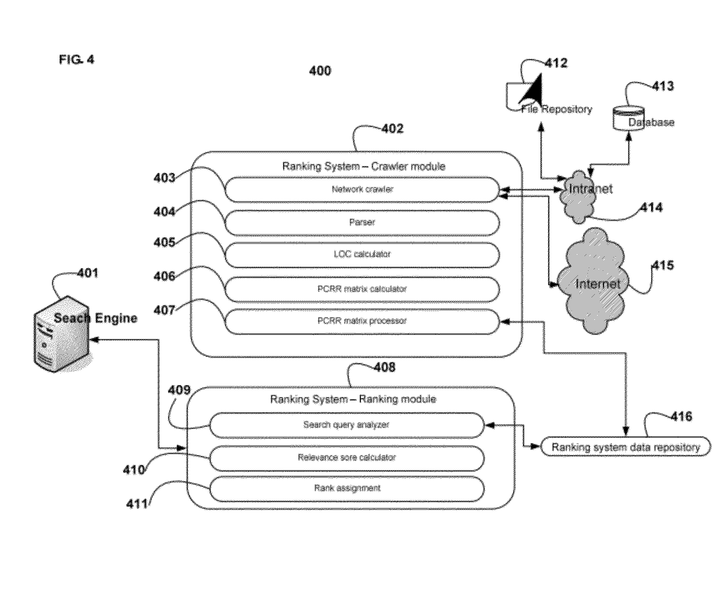

FIG. 4 illustrates ranking system shown in FIG. 2 in more details. Embodiment described here is one of many possible embodiments of the claim and in no way limits the scope of the claim. Following is the list of the components described in FIG. 4:

401. Search Engine

402. Ranking system—crawler module

403. Network crawler sub-module

404. Parser: Web sites/web pages/documents parser sub-module

405. LOC calculator: LOC(s,p) calculator sub-module

406. PCRR matrix calculator: PCRR(key1,key2) and PCRR matrix calculator sub-module

407. PCRR matrix processor: Sub-module to update ranking system data repository 416

408. Ranking system—ranking module

409. Search query analyzer: Sub-module to send the search query to ranking system data repository 416 to fetch PCRR matrix and details of the web sites/web pages/documents containing search words in PCRR matrix as key words

410. Relevance score calculator: Sub-module to calculate relevance score for each of the web sites/web pages/documents based on the PCRR matrix returned by ranking system data repository 416

411. Rank assignment: Sub-module to prepare list of web sites/web pages/documents ranked on the basis of the relevance score

412. File based repository, for storing web site content and documents on intranet

413. Database based repository, for storing web site content and documents on intranet

414. Intranet network

415. Internet network

416. Ranking system data repository

Following is the detailed description of the working of ranking system—crawler module 402. Purpose of ranking module—crawler module 402 is to crawl intranet/internet and create key word PCRR matrix for the web sites/web pages/documents on intranet/internet. Sub-module network crawler 403 will identify web sites/web pages/documents on internet/intranet for the purpose of processing and creating key word PCRR matrix. Sub-module 403 may or may not be configured to identify web sites/web pages/documents on the bases of certain criteria. For example, criteria can be to identify only ‘.org’ sites on internet. Sub-module 403 will pass-on the details of the web sites/web pages/documents identified to Parser sub-module 404. Purpose of parser sub-module 404 is to make necessary conversions and create textual equivalent, if required, of the web sites/web pages/documents identified. Parser sub-module 404 will convert web sites/web pages/documents such as, but not limited to, web sites/web page/documents with content in tabular format or having dynamic content. Parser sub-module 404 will pass-on the content, either original content or converted content, to LOC calculator sub-module 405. Purpose of LOC calculator sub-module 405 is to identify key words for the web sites/web pages/documents and then calculate LOC for each of the key words. Sub-module 405 can identify key words either by analyzing the content or by using other techniques such as, but not limited to, using web site/web page/document metadata or header. Once sub-module 405 has identified the key words, it will calculate LOC(s,p). For example, consider that sub-module 405 is analyzing content of document, Doc1, having content as follows:

“Ford F150 is a very good truck, I am very much satisfied with it. Ford F150 has received very good consumer reviews and that's the reason I brought this truck. Only problem is lack of power, I wish I had purchased Ford F350. Ford F150 may be under powered, but fuel economy is superb. Ford F150 has been placed at top 5 most fuel efficient trucks. Other advantage of Ford F150 is that my wife can also drive it very easily. Ford dealer is located close to our house and it's easy for me to go get my F150 serviced in no time whenever it's needed. Since I brought my Ford F150 in January 2010, I have had no problems. It's been good 2010 so far. Some Ford F150 models seem to develop cracked paint, but luckily I am fine”.

Sub-module 405 will first identify key words, let's assume that sub-module 405 identifies “Ford”, “F150”, “2010” as key words. After key words are identified, sub-module 405 will calculate LOC for each of the key words. Following list shows the LOC for each of the key words that sub-module 405 will calculate based on position of sentence in which key words appear, and the position of the key words within the sentence.

LOC(Ford): (1,1),(2,1),(3,12),(4,1),(5,1),(6,4),(7,1),(8,5),(10,2)

LOC(F150): (1,2),(2,2),(4,2),(5,2),(6,5),(7,18),(8,6),(10,3)

LOC(2010): (8,9),(9,4)

First value of LOC(Ford) is shown as (1,1) because key word ‘Ford’ appears in 1^{st} sentence as the 1^{st} word in the sentence.

Sub-module 405 will pass-on the web site/web page/document details along with the LOC(key word) list to sub-module 406. Purpose of sub-module 406 is to calculate PCRR(Keyword-x,Keyword-y) and then calculate PCRR matrix, based on PCRR(keyword-x,keyword-y), consisting of PCRR for all the possible combinations of the key word pairs. Picking up from the example described previously for sub-module 405, let's assume that sub-module 406 has following list of LOC:

LOC(Ford): (1,1),(2,1),(3,12),(4,1),(5,1),(6,4),(7,1),(8,5),(10,2)

LOC(F150): (1,2),(2,2),(4,2),(5,2),(6,5),(7,18),(8,6),(10,3)

LOC(2010): (8,9),(9,4)

PCRR can be calculated using, but not limited to, statistical methods or any other suitable mathematical formula. For the sake of simplicity and clarity, calculations shown below are based on assumption that sub-module 406 uses following formula to arrive at PCRR(keyword-x,keyword-y)

PCRR(keyword-x, keyword-y)=(n**2)*Σ1/(abs(x−y))

Where

n=number of sentences in with both key words (keyword-x and keyword-y) occur together. So for calculating PCRR(Ford,F150), LOC(Ford): (3,12) will be ignore as “F150” doesn't occur in 3^{rd} sentence.

x=position of keyword-x in the sentence

y=position of keyword-y in the sentence

abs(x−y)=absolute value of the difference between numbers x and y. So value of abs(3−4) will be 1 and value of abs(4−3) will also be 1

Σ=summation of the series. For e.g., if x is a series: [symbol] , then Σ1/x=(1/1+1/3+1/4)

*=multiplication, so 2*4=8

**=square, so 3**2=3*3=9

| | | | | | PCRR(Ford, |
|---|---|---|---|---|---|
| | | | | | F150) |
| Ford | F150 | | | Σ1/ | (n**2) * Σ1/ |
| x | y | abs(x − y) | 1/abs(x − y) | (abs(x − y)) | (abs(x − y)) |
| 1 | 2 | 1 | 1 | 7.058823529 | 451.76471 |
| 1 | 2 | 1 | 1 | | |
| 1 | 2 | 1 | 1 | | |
| 1 | 2 | 1 | 1 | | |
| 4 | 5 | 1 | 1 | | |
| 1 | 18 | 17 | 0.05882353 | | |
| 5 | 6 | 1 | 1 | | |
| 2 | 3 | 1 | 1 | | |

n 8
n**2 64

| | | | | | PCRR(Ford, |
|---|---|---|---|---|---|
| | | | | | 2010) |
| Ford | 2010 | | | Σ1/ | (n**2) * Σ1/ |
| x | y | abs(x − y) | 1/abs(x − y) | (abs(x − y)) | (abs(x − y)) |
| 5 | 9 | 4 | 0.25 | 0.25 | 0.25 |

n 1
n**2 1

| | | | | | PCRR(F150, |
|---|---|---|---|---|---|
| | | | | | 2010) |
| F150 | 2010 | | | Σ1/ | (n**2) * Σ1/ |
| x | y | abs(x − y) | 1/abs(x − y) | (abs(x − y)) | (abs(x − y)) |
| 6 | 9 | 3 | 0.33333333 | 0.333333333 | 0.3333333 |
| n 1 | | | | | |
| n**2 1 | | | | | |

PCRR Matrix

| | Ford | F150 | 2010 |
|---|---|---|---|
| Ford | — | 451.76 | 0.25 |
| F150 | 451.76 | — | 0.33 |
| 2010 | 0.25 | 0.33 | — |

Sub-module PCRR matrix calculator 406, will then pass-on the web sites/web pages/documents details along with the PCRR matrix to sub-module PCRR matrix processor 407. Purpose of sub-module 407 is to call ranking system data repository 416, to store PCRR matrix along with the web sites/web pages/documents details. Web sites/web pages/documents details can be, but not limited to, their location (URL) and/or content.

Ranking system data repository 416, stores web sites/web pages/documents details along with the PCRR matrix. Sub-module 416 can store the details and PCRR matrix in many ways such as, but not limited to, database, files, in-process memory and distributed databases.

Following is the detailed description of the working of ranking system—ranking module 408.

Search engine 401 sends the search query, submitted by the user, to ranking module 408. As is shown in FIG. 4, ranking module 408 consists of sub-modules: 409, 410, and 411. Ranking module 408 construct in FIG. 4 has been simplified for the sake of simplicity and clarity, in actual implementation this will be much more complex.

Sub-module search query analyzer 409 processes the search query received from search engine 401. Search query analyzer 409 will first break the search query into search words. There are numerous ways in which search query can be broken into the list of search words. A simple example of creating a list of search words could be, a case where query string “Ford F150 2010” is received from search engine and search query analyzer 409 breaks the query string into search word list: {“Ford”,“F150”,“2010”}. Scope of the claim, in no way, will be limited by different implementations of creation of search word list from search query. Query analyzer 409 will then send request, containing search words, to ranking system data repository 416 to get details of web sites/web pages/documents along with their corresponding PCRR matrix. Ranking system data repository 416 will identify web sites/web pages/documents having search words as key words in their PCRR matrix and will return web sites/web pages/documents details along with their corresponding PCRR matrix. Relevance score calculator sub-module 410 will use web sites/web pages/documents details and their corresponding PCRR matrix, sent by ranking system data repository 416, to calculate relevance score for each of the web sites/web pages/documents. Relevance score calculator sub-module 410 will use the search words identified by sub-module search query analyzer 409, and calculate the relevance score for the web sites/web pages/documents based on the PCRR value for each of the search words identified by sub-module 409.

For the sake of clarity and simplicity assume that search query analyzer sub-module 409 identified list of search words as: {“Ford”,“F150”,“2010”} and subsequently receives 2 documents and their PCRR matrix, from ranking system data repository 416, as shown below:

PCRR-Doc1

| | Ford | F150 | 2010 |
|---|---|---|---|
| Ford | — | 27 | 8.25 |
| F150 | 27 | — | 3.33 |
| 2010 | 8.25 | 3.33 | — |

PCRR-Doc2

| | Ford | F150 | 2010 |
|---|---|---|---|
| Ford | — | 451.76 | 0.25 |
| F150 | 451.76 | — | 0.33 |
| 2010 | 0.25 | 0.33 | — |

Score calculator sub-module 410 will then identify PCRR(search word-x, search word-y) for each possible search word pair for Doc1 and Doc2, from the PCRR matrix returned by ranking system data repository 416, as shown below:

Doc1:

PCRR(Ford, F150)=27

PCRR(Ford, 2010)=8.25

PCRR(F150,2010)=3.33

Doc2:

PCRR(Ford, F150)=451.76

PCRR(Ford, 2010)=0.25

PCRR(F150,2010)=0.33

There are numerous methods that sub-module 410 can use to calculate relevance score for web sites/web pages/documents. Following shows the relevance score calculated based on simple comparison of PCRR search word pair score:

| | (Ford, F150) | (Ford, 2010) | (F150, 2010) |
|---|---|---|---|
| Doc1 | 2 | 1 | 1 |
| Doc2 | 1 | 2 | 2 |

As shown in the table above, Doc1 has been assigned score of 2 for (Ford, F150) because its rank out of 2 documents for PCRR(Ford, F150) is 2^{nd} [Doc1-PCRR(Ford,F150)=27 and Doc2-PCRR(Ford,F150)=451.76]. Similarly Doc1 has been assigned score of 1 for (Ford,2010) as its rank out of 2 documents for PCRR(Ford,2010) is 1^{st}. Doc1 has been assigned score of 1 for (F150, 2010) as its rank out of 2 documents for PCRR(F150,2010) is 1^{st}. Similarly score has been calculated for Doc2. Rank assignment sub-module 411 will calculate the rank of each of web sites/web pages/documents returned by ranking system data repository 416. Referring to the example explained for relevance score calculator sub-module 410, let's assume that sub-module 411 ranks the Doc1 and Doc2 based on simple method of summation of the relevance score for each search word pair. So Doc1 score: 4 (2+1+1) and Doc2 score: 5(1+2+2). Since Doc1 ranks higher then Doc2, sub-module 411 will rank documents as follows:

Doc1

Doc2

Ranked list of web sites/web pages/documents will then be returned by ranking system—ranking module 408 to the search engine 401. Search engine 401 will in-turn return the list to the user. User, in response to the search query, will see the documents list as:

Doc1

Doc2

Indicating that Doc1 is relatively more relevant then Doc2.

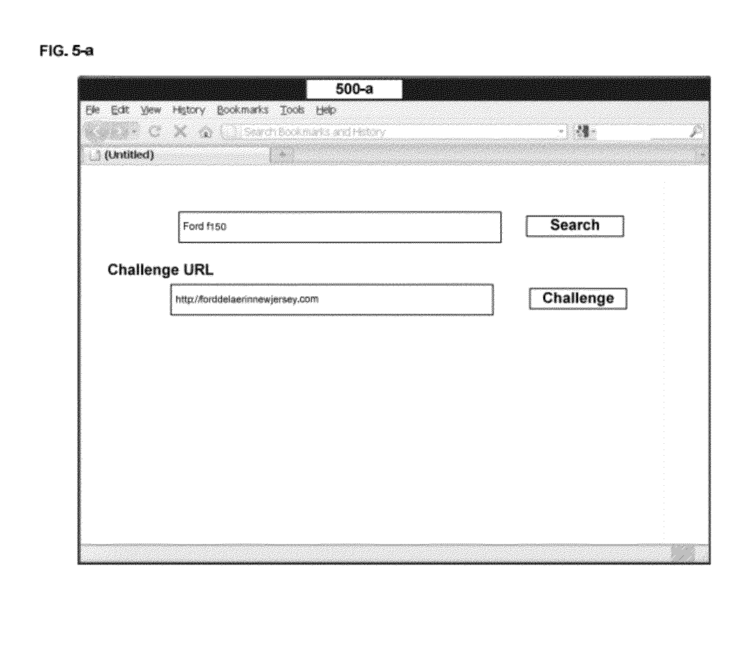

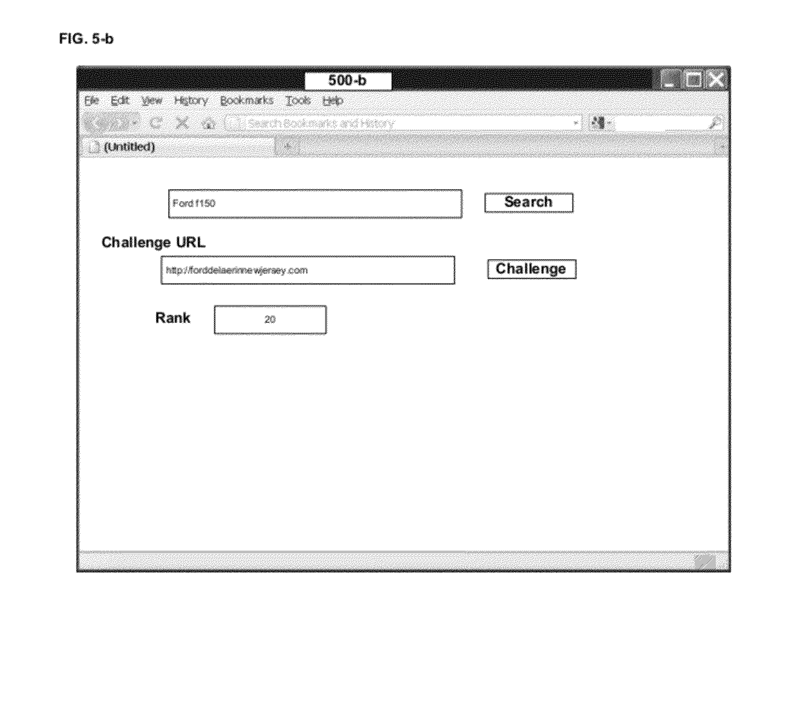

FIGS. 5-a and 5-b show simple user interfaces that can be created to allow user to challenge the rank of web sites/web pages/documents displayed. As shown in FIG. 5-a, user can enter search word and URL of web site/web page/document, to challenge for, and click ‘Challenge’ button. As shown in FIG. 5-b, after user clicks ‘Challenge’ button system will calculate the rank of the web site/web page/document, corresponding to the URL entered by the user, and display the rank to the user. Due to dynamic nature of the internet/intranet, it's possible that the web site/web page/document, used to challenge the ranking by the user, has higher ranking and is not displayed in the list of web sites/web pages/documents list originally shown to the user. In this case, list of web sites/web pages/documents displayed to the user will be updated.

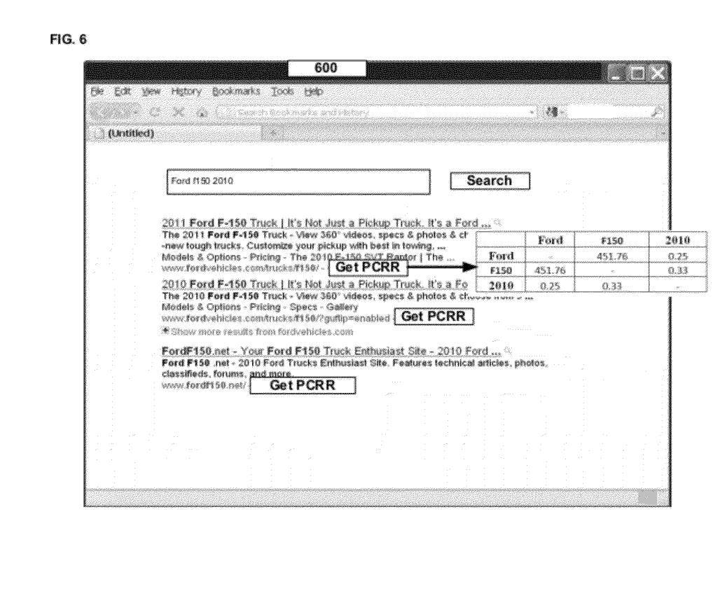

FIG. 6 displays user interface that can be developed in order to show PCRR matrix of a give web site/web page/document. As shown in FIG. 6, user has ability to see PCRR matrix by clicking ‘Get PCRR’ button displayed against all the web sites/web pages/documents shown in the list.

### Extensions and Alternatives

In the foregoing specifications, embodiments of the invention have been described with reference to numerous specific details that may vary from implementation to implementation. Thus, the sole and exclusive indicator of what is the invention, and is intended by the applicant to be the invention, is the set of claims that issue from this application, in the specific form in which such claims issue, including any subsequent corrections. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

Furthermore, the invention has been described with reference to specific embodiments thereof. It will, however, be evident that various modifications and changes may be made thereto without departing from the broader spirit and scope of the invention.

In addition, in this description certain process steps are set forth in a particular order, and alphabetic and alphanumeric labels may be used to identify certain steps. Unless specifically stated in the description, embodiments of the invention are not necessarily limited to any particular order of carrying out such steps. In particular, the labels are used merely for convenient identification of steps, and are not intended to specify or require a particular order of carrying out such steps.

What is claimed is:

1. A web sites, web pages and documents ranking system in which queries, comprising of search words, are submitted on internet or intranet, by users, who receive, in response, a list of web sites or web pages or documents ranked on the basis of the relevance score; a method of determining relevance score of web site or web page or document comprising acts of: (A) obtaining search words from the query submitted by the user; (B) the act of calculating paired positional correlation of the search words in the web sites or web pages or documents, in the realm of the search; (C) creating positional correlation matrix from search words paired positional correlation; (D) ranking web sites or web pages or documents, in the realm of the search, on the basis of relevance score, calculated using positional correlation matrix.

2. The computer implemented, either though software or hardware or a combination of both software and hardware, method of claim 1, wherein the act (B) further comprises of parsing web sites or web pages or documents and creating a textual equivalent of the web sites or web pages or documents content, if the content is in tabular format.

3. The computer implemented, either though software or hardware or a combination of both software and hardware, method of claim 2 further comprises of using rows or columns or any other combinations of table cells, to create textual equivalent, if content of web site or web page or document is in tabular form.

4. The computer implemented, either though software or hardware or a combination of both software and hardware, method of claim 3 further comprises of replacing tabular data with the textual equivalent, and storing textual equivalent in computer processor readable format.

5. The computer implemented, either though software or hardware or a combination of both software and hardware, method of claim 2 further comprises of creating web sites or web pages or documents equivalent, for the calculation of relevance score, if web sites or web pages or documents are generated dynamically.

6. The computer implemented, either though software or hardware or a combination of both software and hardware, method of claim 2 further comprises of parsing web sites or web pages or documents and indexing search words such that each occurrence of the search words is represented by location coordinates: LOC(s,p) where ‘s’ represent the index of sentence in which the search word occurs and ‘p’ represent the position of search word within the sentence, e.g. LOC (3,5) would mean that search word occurs at 5^{th} position in 3^{rd} sentence in the web site or web page or document.

7. The computer implemented, either though software or hardware or a combination of both software and hardware, method of claim 3 further comprises of calculating paired positional correlation of the search words based on matching location coordinates. So if location coordinates of search word: SW1 are (2,3),(3,6),(6,8),(9,10) and location coordinates of search word: SW2 are (2,5),(6,9),(9,14),(11,23) then paired positional correlation PCRRsw1sw2 will be calculated based on data SW1: (2,3),(6,8),(9,10) and SW2: (2,5),(6,9),(9,14). Location coordinates with matching sentence index are only considered in calculating paired positional correlation.

8. The computer implemented, either though software or hardware or a combination of both software and hardware, method of claim 1, wherein the act (C) further comprises of calculating and storing positional correlation matrix, based on the paired positional correlation. Positional correlation matrix can be represented, but not limited to, in a two dimensional form, as shown below for the 3 search words SW1, SW2, SW3:

| | SW1 | SW2 | SW3 |
|---|---|---|---|
| SW1 | 1 | PCRRsw1sw2 | PCRRsw1sw3 |
| SW2 | PCRRsw2sw1 | 1 | PCRRsw2sw3 |
| SW3 | PCRRsw3sw1 | PCRRsw3sw2 | 1 |

9. The system of claim 8, further comprising: storing search word positional correlation matrix in machine and/or human readable format.

10. The system of claim 1, further comprising: calculating positional correlation matrix, for the web sites or web pages or documents, in advance. Positional Correlation Matrix will be calculated for the Key Words. Key Words are the words which web site or web page or document claims to have most relevant information for.
Following shows positional correlation matrix for 3 key words KW1, KW2, KW3:

| | KW1 | KW2 | KW3 |
|---|---|---|---|
| KW1 | 1 | PCRRkw1kw2 | PCRRkw1kw3 |
| KW2 | PCRRkw2 kw1 | 1 | PCRRkw2kw3 |
| KW3 | PCRRkw3kw1 | PCRRkw3kw2 | 1 |

11. The system of claim 10, further comprising: storing key words positional correlation matrix in machine and/or human readable format.

12. The system of claim 11, further comprising: allowing manual modification of key words positional correlation matrix.

13. A computer implemented, either through software or hardware or a combination of both software and hardware, method of claim 1 wherein the act (D) further comprises of displaying positional correlation matrix for each of the web sites or web pages or documents in the list displayed to the user.

14. A system of challenging the rankings of web sites or web pages or documents, comprising: computer implemented, either though software or hardware or a combination of both software and hardware, method of accepting, but not limited to, (1) URL of web site or web page or document, to challenge for; (2) Search words, used to search web sites or web pages or documents, from the user. On the basis of user inputs, system re-ranks the web sites/web pages/documents in the list and/or responds back to the user with the reason of rejecting the challenge along with positional correlation matrix and/or rank of the web site or web page or document, corresponding to the URL submitted by the user.
